(19) United States
(12) Patent Application Publication
(10) Pub. No.: US 2007/0166187 A1
(43) Pub. Date: Jul. 19, 2007

(54) Stabilization of paricalcitol using chlorobutyl or chlorinated butyl stoppers

(76) Inventors: Jing Feng Song, Gurnee, IL (US); Dennis A. Stephens, Mt. Prospect, IL (US)

Correspondence Address: ROBERT DEBERARDINE;ABBOTT LABORATORIES, 100 ABBOTT PARK ROAD, DEPT. 377/AP6A, ABBOTT PARK, IL, 60064-6008, US

(21) Appl. No.: 11/334,060

(22) Filed: Jan. 18, 2006

(51) Int. Cl. B01J 19/00

(52) U.S. Cl. 422/40; 422/41

(57) ABSTRACT

This invention relates to a method of enhancing the stability of paricalcitol solution in a container by using a chlorobutyl or chlorinated butyl stopper in the container.

### TECHNICAL FIELD

This invention relates to a method of enhancing the stability of paricalcitol solution in a container by utilizing a chlorobutyl or chlorinated butyl stopper.

### BACKGROUND INFORMATION

Zemplar® (paricalcitol) Injection is a vialed product currently marketed for treatment of secondary hyperparathyroidism associated with renal failure. The vialed product, which utilizes an elastomeric enclosure that is composed of a butyl material, has a relatively shorter shelf-life of 12 months in comparison to the same solution stored in a glass ampule. The shorter shelf-life has been directly attributed to the stopper which catalyzes the degradation of the paricalcitol and results in an observed loss of potency over time. Shelf-life studies at elevated temperatures have demonstrated a similar potency loss in the paricalcitol solution that is stored in an injection vial containing a stopper which is composed of the same butyl material currently used in the marketed product. The loss of potency in the elevated temperature study is reflective of what has been observed during shelf-life stability studies at 25° C. Thus, there is a need for a stoppered container in which a solution containing paricalcitol degrades at a slower rate than in the currently marketed container.

All patents and publications referred to herein are hereby incorporated in their entirety by reference.

### SUMMARY OF THE INVENTION

It is a primary object of this invention to provide a method of increasing the shelf-life of a pharmaceutical when stored in a container sealed with a halogenated butyl polymer stopper for sufficient time and under conditions that will prevent decomposition. The increase in the shelf-life of the pharmaceutical is due to an increase in the stability of the pharmaceutical when stored with the halogenated butyl polymer stopper. The increase in stability of the pharmaceutical is demonstrated by a slower rate of decomposition when the pharmaceutical is stored in a container sealed with the halogenated butyl polymer stopper. Moreover, the increase in the stability of the pharmaceutical is directly related to the composition of the stopper. In one particular embodiment of the present invention, there is disclosed a method of preventing the decomposition of a pharmaceutical, comprising storing the pharmaceutical in a glass vial stoppered with a stopper comprising a chlorobutyl or chlorinated butyl polymer for a time and under conditions sufficient to prevent decomposition.

In another embodiment of the present invention, there is disclosed a method of preventing the decomposition of a vitamin D receptor activator, comprising storing the vitamin D receptor activator in a glass vial stoppered with a stopper comprising a halogenated butyl polymer stopper. Further, in another embodiment of the present invention, there is provided a method of lowering the rate of decomposition of a vitamin D receptor activator stored in a container sealed with a chlorobutyl or chlorinated butyl stopper. In a further embodiment of the present invention, there is disclosed an increase in the stability and shelf-life of a vitamin D receptor activator in solution when stored in a container sealed with a chlorobutyl or chlorinated butyl stopper, wherein the container is selected from the group consisting of a glass vial, a type I glass vial and a syringe.

In one embodiment, there is provided a method of storing a vitamin D receptor activator such as but not limited to paricalcitol, Calcitriol (i.e., Calcijex®) and doxercalciferol (i.e., Hectoral®, Genzyme Corporation, Cambridge, Mass.) in a vial sealed with a chlorobutyl or chlorinated butyl stopper. More particularly, the storage of the paricalcitol or calcitriol in a vial stoppered with the chlorobutyl or chlorinated butyl stopper results in an increase in the shelf-life of the drug. The greater stability of the paricalcitol or calcitriol when stored in a vial sealed with a chlorobutyl or chlorinated butyl stopper is the result of a slower rate of decomposition of the paricalcitol or calcitriol when stored in the presence of a stopper. In a preferred embodiment of the present invention, there is disclosed a method of preventing the decomposition of paricalcitol, wherein the shelf-life of paricalcitol in solution is increased compared to a solution of paricalcitol stored in a glass vial sealed with a stopper consisting of a polymer stopper comprising a polymer selected from the group consisting of butyl, bromobutyl, ethylene propylenediene monomer or polyisoprene.

In another embodiment, there is disclosed a method of preventing the decomposition of paricalcitol in a solution that will be used for intravenous administration, comprising storing the solution in a glass vial sealed with a chlorobutyl or chlorinated butyl stopper. In a further embodiment of the present invention, there is disclosed a method of preventing the decomposition of paricalcitol in a solution that is stored in a preloaded syringe, comprising adding paricalcitol to a syringe, wherein the syringe stopper is comprised of chlorobutyl or chlorinated butyl polymer, and maintaining the syringe for a time and under conditions sufficient to prevent decomposition of the solution.

The present invention discloses a method of evaluating stoppers of different compositions to measure the relative rates of decomposition of paricalcitol stored in vials sealed with the stoppers in an accelerated shelf-life study. The method described compares the relative rate of decomposition of a solution of paricalcitol when stored in glass vials sealed with stoppers of various composition, including the current commercially available product, with the same solution stored in a glass ampule. Paricalcitol (Zemplar®) and Calcitriol (Calcijex®) are currently marketed by Abbott Laboratories (Abbott Laboratories, 100 Abbott Park Rd, Abbott Park, Ill. 60064) as vitamin D receptor activators and are related in structure.

The shelf-life of a pharmaceutical is directly correlated to the rate of decomposition of the drug in its stored state whether solid or in solution. Certain materials may be involved and may contribute to decomposition such as formulations, carriers or storage vessels in contact with the pharmaceutical and/or solution. To determine whether the glass or solution in which the paricalcitol is stored is involved in its decomposition, the decomposition of paricalcitol stored in solution in a glass ampule was measured.

The current shelf-life of the commercially available injection vial containing a solution of paricalcitol is 1 year. In an embodiment of the present invention, there is disclosed a method of increasing the shelf-life of paricalcitol to about 1 to 3 years. In a preferred embodiment of the present invention, there is disclosed a method of increasing the shelf-life of a solution of paricalcitol to about 2 to 3 years.

Certain formulations of a therapeutically effective amount of a vitamin D receptor activator are composed of a mixture of 50% of an organic solvent in water. The organic solvent is typically a mixture of 15% to about 30% (v/v) ethanol in a glycol derivative such as but not limited to ethylene or propylene glycol. A typical injection formulation for a vitamin D receptor activator is about 1-10 mcg/mL in a solution comprising 40-60% (v/v) aqueous alcoholic solution. For example, one preferred formulation for paricalcitol is about 2 to 5 mcg/mL of paricalcitol in a mixture of water, propylene glycol and ethanol in the ratio of 50:30:20 (v/v). Certain formulations of vitamin D receptor activators are described in U.S. Pat. No. 6,136,799 and U.S. Pat. No. 6,361,758 are hereby, incorporated in their entirety by reference.

### BRIEF DESCRIPTION OF THE DRAWINGS

FIG. 1 illustrates the stability results of paricalcitol solution (without argon headspace gassing) in Study 1.

FIG. 2 illustrates the stability results of paricalcitol solution (with argon headspace gassing) in Study 1.

FIG. 3 illustrates the stability results of paricalcitol solution (without headspace argon gassing) in Study 2.

FIG. 4 illustrates the stability results of paricalcitol solution (with headspace argon gassing) in Study 2.

FIG. 5 illustrates the stability results of paricalcitol solution (without argon headspace gassing) in Study 3.

FIG. 6 illustrates the stability Results of paricalcitol solution (with argon headspace gassing) in Study 3.

FIG. 7 illustrates the stability results of paricalcitol solution (without argon headspace gassing) in Study 4.

FIG. 8 illustrates the stability results of paricalcitol solution (with argon headspace gassing) in Study 4.

FIG. 9 illustrates the stability results of paricalcitol solution (without argon headspace gassing) in Study 5.

FIG. 10 illustrates the stability results of paricalcitol solution (with argon headspace gassing) in Study 5.

FIG. 11 illustrates the potency profiles of Zemplar® IV formulation with different amounts of BHT at 80° C.

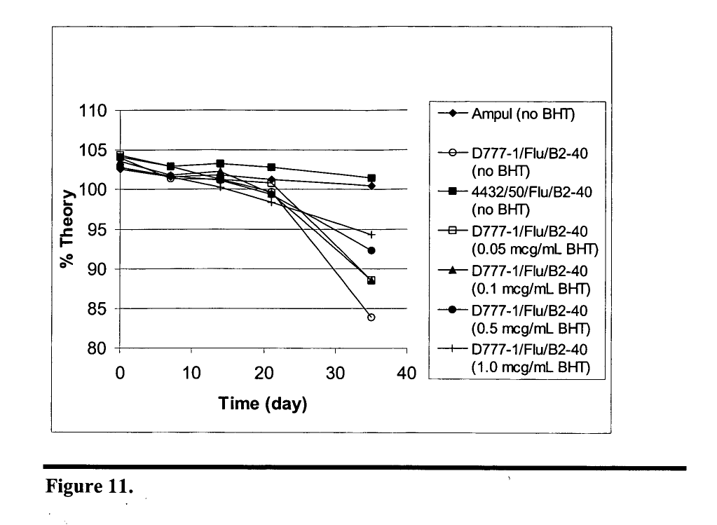

### DETAILED DESCRIPTION OF THE INVENTION

The present invention discloses a stoppered vial in which a solution containing Paricalcitol degrades at a slower rate than in the currently marketed container. The slower rate of decomposition of paricalcitol in the presence of the new stopper results in a longer shelf-life when compared to the currently marketed vial samples. This slower rate of decomposition of the paricalcitol solution provides a higher purity drug to the public and allows for an extension of the expiration date of the marketed paricalcitol injectable.

The vials used throughout the accelerated shelf-life study to store the solution of paricalcitol within the study were Type I, 5 mL vials composed of Flint glass with a 13 mm finish (obtained from Hospira, 4285 North Wesleyan Blvd., Rocky Mount, N.C. 27804). The ampule throughout the accelerated shelf-life study used to store the solution of paricalcitol within the study were Type I, Flint sulfur treated 5 mL ampule (obtained from Hospira, 4285 North Wesleyan Blvd., Rocky Mount, N.C. 27804).

The stoppers compared within the study are listed in Table 1. The Ashland stoppers: Ashland 5212, Ashland 5287, Ashland 5153, Ashland 5337, Ashland 5330, Ashland 13 mm POE, Ashland 20 mm POE, Ashland POE and Ashland Kraton were obtained from Hospira, 268 East Fourth Street, Ashland, Ohio 44805. The Daikyo and West stoppers were obtained from West Pharmaceutical Services, 101 Gordon Drive, Lionville, Pa. 19341.

Paricalcitol was obtained from approved Abbott Laboratories' inventories (Abbott Laboratories, 100 Abbott Park Rd, Abbott Park, Ill. 60064).

TABLE 1
Description of Tested Stoppers

| # | Stopper | Rubber Type | Coating |
|---|---|---|---|
| 1 | Daikyo D777-1 | Butyl | N/A |
| 2 | Daikyo D777-1 | Butyl | Flurotec |
| 3 | Daikyo D777-1 | Butyl | Flurotec & B2-40 |
| 4 | Daikyo D777-1 | Butyl | Flurotec & B2-44 |
| 5 | Daikyo D777-3 | Butyl/Chlorobutyl | Flurotec & B2-40 |
| 6 | Daikyo D-21-7 | Chlorinated butyl | Flurotec & B2-40 |
| 7 | Ashland 5212^{b} | Chlorobutyl | N/A |
| 8 | Ashland 5212^{b} | Chlorobutyl | Tefzel |
| 9 | Ashland 5287 | Chlorobutyl | N/A |
| 10 | Ashland 5153^{b} | Polyisoprene/ | N/A |
| | | Chlorobutyl | |
| 11 | Ashland 5153 | Polyisoprene/ | Tribofilm |
| | | Chlorobutyl | |
| 12 | Ashland 5337^{b} | EPDM | N/A |
| 13 | Ashland 5330^{b} | Bromobutyl | N/A |
| 14 | Ashland 5212 | Chlorobutyl | Plasma Coating #1 |
| 15 | Ashland 5212 | Chlorobutyl | Plasma Coating #2 |
| 16 | Ashland 5212 | Chlorobutyl | Prop-coat |
| 17 | Ashland 5212 | Chlorobutyl | Parylene |
| 18 | Ashland 13 mm POE | Unknown | N/A |
| 19 | Ashland 20 mm POE | Unknown | N/A |
| 20 | Ashland POE | Unknown | Parylene C |
| 21 | Ashland POE | Unknown | F8815 |
| 22 | Ashland Kraton | Unknown | Parylene C |
| 23 | West 4405/50 | Bromobutyl | Teflon |
| 24 | West 4405/50 | Bromobutyl | Teflon & B2-40 |
| 25 | West 4432/50 | Chlorobutyl | Teflon |
| 26 | West 4432/50 | Chlorobutyl | Flurotec & B2-40 |
| 27 | West 4432/50 | Chlorobutyl | N/A |

a 20 mm stoppers
^{b}N/A = Not Applicable
c Plasma coating consists of a silicon dioxide coating applied using a plasma coating technique
d Prop-coat consists of a coating of propylene

### EXAMPLE I

In order to effectively evaluate different container closures, an accelerated stability model was devised, wherein vials that contained a paricalcitol solution and were sealed with 27 different types of stoppers were stored inverted and protected from light at 80° C. for 21 days. The vials were different only in the composition of the stoppers which were obtained from commercially available sources. Throughout the 21 day trial, samples were removed at day 2, 7, 14 and 21, and the contents of the vial were analyzed by HPLC (High Pressure Liquid Chromatography) to determine the concentration of the test compound paricalcitol compared to a control sample of known concentration. The control sample consisted of a paricalcitol injection solution stored in a sealed glass ampule which maintained 100% potency for the entirety of the test (21 days). The relative concentration of the paricalcitol in the vials stored with test stoppers compared to the control sample was measured indicating stability of the paricalcitol over the 21 day test. In addition, the accelerated shelf-life study conditions were conducted on an identical vial wherein the headspace of the vials was blanketed with argon gas above the paricalcitol solutions prior to sealing with the appropriate stopper. The argon blanketed sample containing a lower concentration of oxygen was compared to the control sample to determine the stability of the test compound in a more inert atmosphere. The 80° C. 21 day rapid screening method of solutions of paricalcitol in the presence of different stoppers was designed to predict the stability of the test compound (i.e., paricalcitol) relative to the containers that are used in the current marketed product.

Preparation and Stability Test Procedure of Paricalcitol Solution:

The paricalcitol solution preparation: (5 mcg/mL in water-propylene glycol-ethanol/50:30:20; as defined under USP28-NF23 Page 1471 guidelines) contains not less than 90.0 percent and not more than 110.0 percent of the labeled amount of paricalcitol (C₂₇H₄₄O₃). 1 mL of solution was added to a 5 mL or 10 mL (for 20 mm stopper) Type 1 glass vial. The vials were sealed with the various types of stoppers. In order to evaluate the effect of oxygen, a second series of identical vials was blanketed with argon prior to capping with the stoppers. All of the samples were stored inverted in a light-protected, 80° C. oven to obtain maximum contact between solution and the stopper. Ampule samples (with no headspace argon gassing) were prepared and stored along with vials under the same condition to serve as a control. At least 2 samples for each type of stopper were pulled out at 2, 7, 14, and 21 day time points and assayed using HPLC without further dilution. Paricalcitol concentration profiles from the vials containing different composition stoppers were compared to the same solution packaged in ampules. The relative concentration of remaining paricalcitol was plotted over the course of the 21 day test to determine the relative stability of paricalcitol in the presence of the test stopper.

HPLC Detection Procedure (as Defined Under USP23-NF23 Page 1470)

Chromatographic system used: The liquid chromatograph was equipped with a 252-nm detector and a 4.6-mm×25-cm column that contains 5-μm packing L1 with a flow rate about 2 mL per minute. The control standard was chromatographed and the peak responses were record as directed for the procedure: the tailing factor was not more than 2.0; and the relative standard deviation for replicate injections was not more than 2.0%.

Separately inject equal volumes (about 100 to 200 μL) of the Standard preparation and the Assay preparation into the chromatograph, record the chromatograms, and measure the responses for the major peaks. Calculate the quantity, in μg, of paricalcitol (C₂₇H₄₄O₃) in each mL of the Injection taken by the formula:
C(r_{U}/r_{S}),
in which C is the concentration, in μg per mL, of paricalcitol in the control standard, calculated on the basis of the content of paricalcitol in the USP Paricalcitol Solution RS; and r_{U} and r_{S} are the paricalcitol peak responses obtained from the test samples and the control standard, respectively.
Results

Five stability studies were conducted to evaluate the stoppers. Ampule and D777-1/FT/B2-40 (commercially used stopper for marketed product) stopper vials served as the controls in each study. The five stability studies were conducted in duplicate, wherein at least two of the samples were prepared with argon headspace gassing and at least two without the argon headspace gassing.

The results consistently showed that storage of the test compound in a glass ampule maintained about 100% potency for the entirety of the test (21 days). The vial samples with the D777-1/FT/B2-40 stopper started to exhibit potency drop at the 7-day time point. Although there was variation in the degradation rate of the sample with the D777-1/FT/B2-40 stopper, the potency loss for this stopper was consistent and reproducible using the 80° C. degradation model. Therefore, because the ampule and D777-1/FT/B2-40 stoppers were consistent and were used as controls in each experiment, the 21 day 80° C. degradation model is effective in predicting stopper performance relative to the D777-1/FT/B2-40 stopper for paricalcitol.

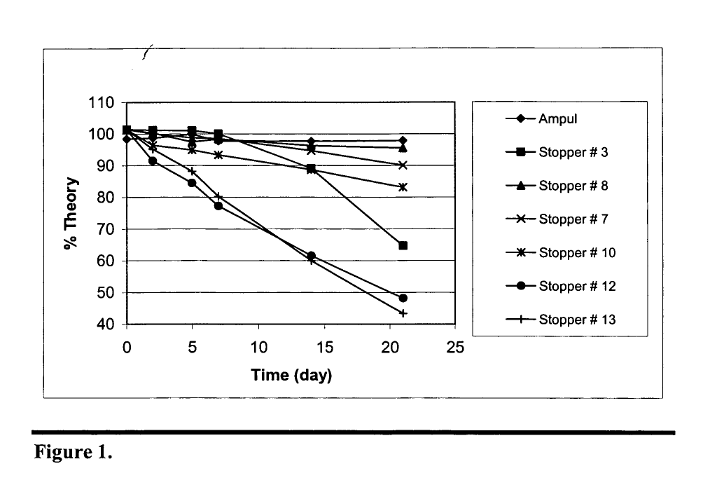

Study 1 compared stoppers #3, 7, 8, 10, 12 and 13 with and without argon headspace gassing. The data of Study 1 for the samples that were stored without the argon headspace (FIG. 1) exhibited a marked decrease in concentration of paricalcitol over the over the 21 day test period. Stopper #8, Ashland chlorobutyl with Tefzel coating, and Stopper #7, Ashland chlorobutyl without the Tefzel coating showed the least degradation over the 21 day test period. The concentration of paricalcitol within the vial having Stopper #8 was comparable to the sample stored in the ampule.

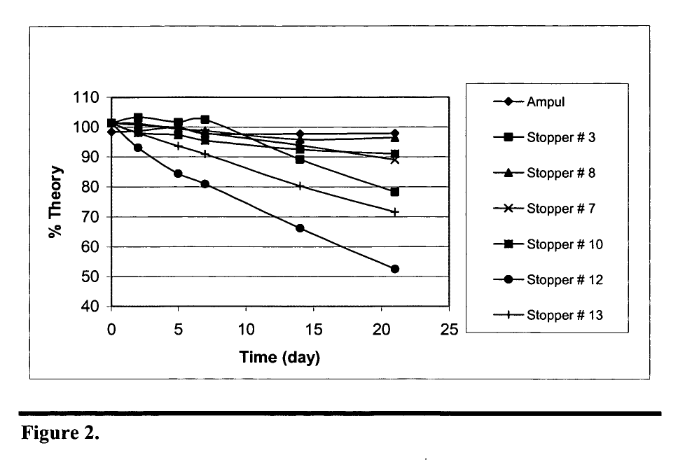

The data of Study 1 comparing the same stoppers with argon headspace gassing (FIG. 2) demonstrated a change in slope in the degradation rates of the paricalcitol for certain samples when compared to the rates of decomposition of the samples without the argon gassing. The change in the degradation rates indicated that certain samples degraded more slowly with the argon filled headspace. Although there were changes in the degradation rates for certain samples, the changes were not significant enough to conclude that oxygen was the only cause of degradation. Again, Paricalcitol was more stable in the samples with chlorobutyl stoppers than in those samples with other stoppers.

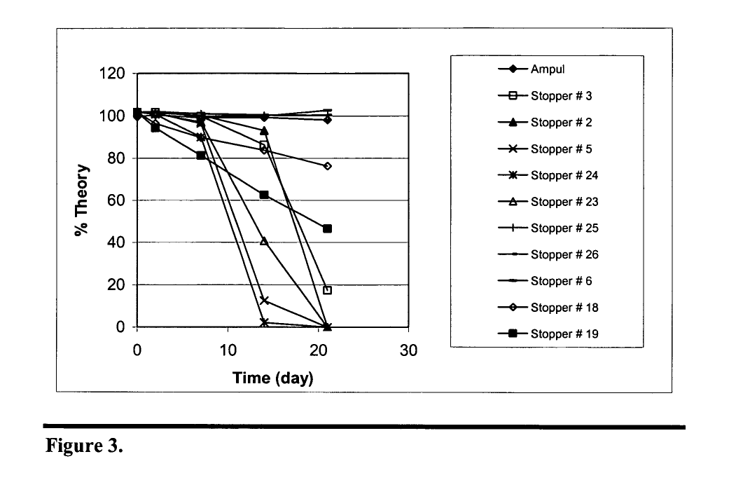

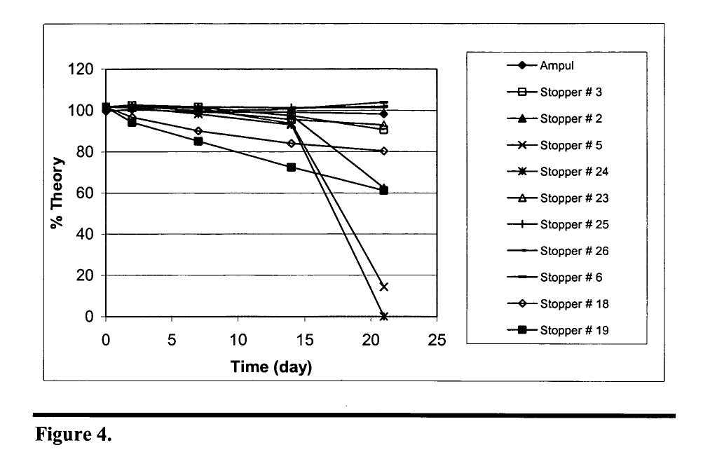

In Study 2, comparisons were made between Daikyo and West stoppers which were made of different materials and contained different coatings. The data of Study 2 for samples without the argon gassing (FIG. 3) demonstrate that the stoppers most compatible with the paricalcitol solution were 6, 25 and 26 which all consisted of either chlorinated butyl or chlorobutyl. The consistent increase in stability of the paricalcitol in the presence of chlorinated butyl or chlorobutyl stoppers (regardless of supplier) was also demonstrated in the samples containing an argon filled headspace. Furthermore, the results of Study 2 showed that paricalcitol concentration remained unchanged for West chlorobutyl and Daikyo chlorinated butyl stoppers over the 21 days at 80° C. The stability profiles of paricalcitol samples with these compatible stoppers were similar to the ampule control. The argon gassing in the vial headspace (FIG. 4) did enhance the stability of paricalcitol for the samples with butyl, bromobutyl, and POE stoppers; however, the concentration of paricalcitol at the 21 day interval was still lowest in these samples when compared to chlorobutyl and chlorinated butyl stopper samples.

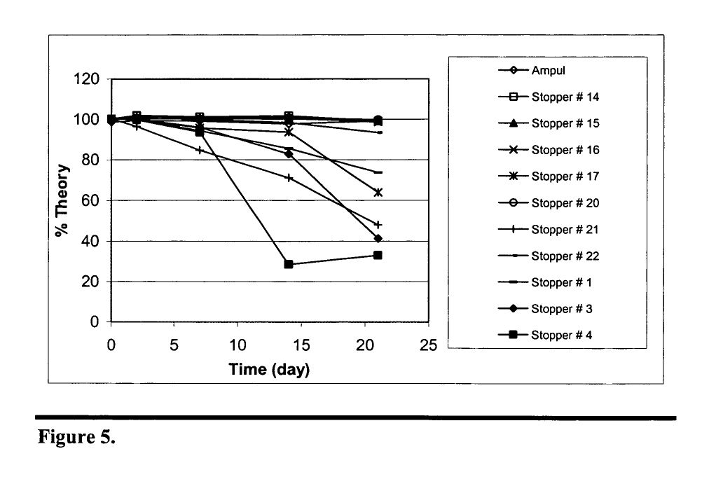

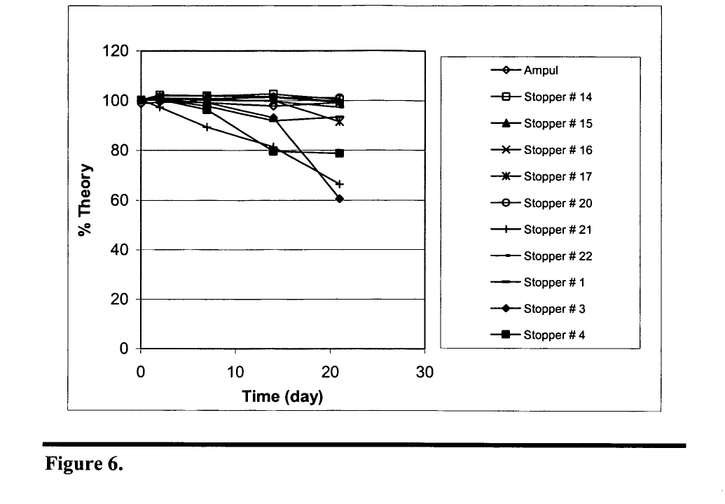

Study 3 compared Ashland 5212 chlorobutyl stoppers with different coating materials. The results of the samples without the argon gassing (FIG. 5) show that Plasma and Prop coatings are compatible with paricalcitol solution due to constant stability profiles. A similar increase in concentration of paricalcitol contained within the samples containing argon headspace gassing of Study 3 (FIG. 6) was measured.

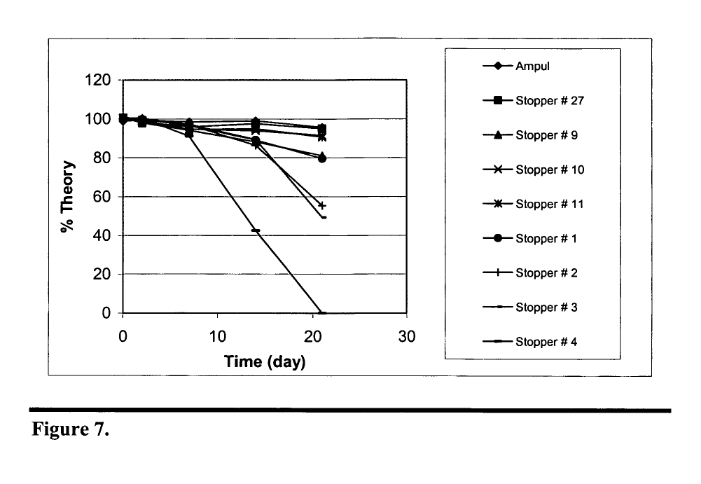

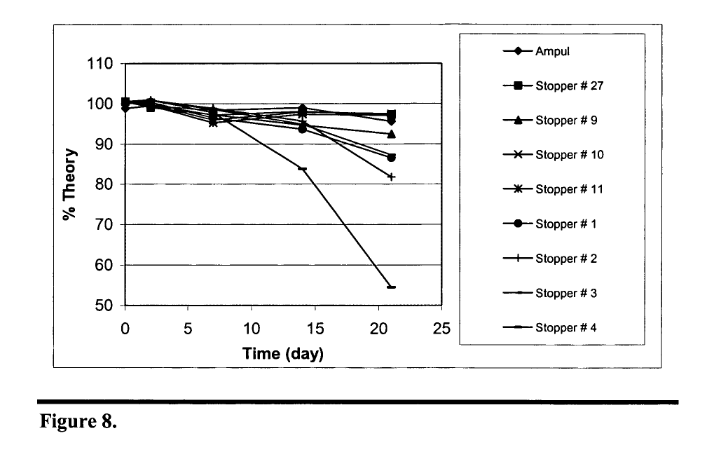

In Study 4, stoppers composed of chlorobutyl (or chlorinated butyl) containing an additional coating or fluorotec, B2-40 or B2-44 were compared. The stoppers consisting of the chlorobutyl material consistently maintained the highest concentration of paricalcitol throughout the 21 day test (FIGS. 7 and 8). The results indicated that West 4432/50 stopper samples performed as well as the ampule sample even without any barrier coating.

Based on the stability results in these four screening studies, chlorobutyl or chlorinated butyl stoppers appeared to be the lead candidates for use in Zemplar® (paricalcitol) injection stored in ampules. The stoppers exhibiting the least decomposition of paricalcitol throughout the test were Ashland 5212/Tefzel, West 4432/50/FT/B2-40, West 4432/50/Teflon, and Daikyo D-21-7/FT/B2-40 stoppers.

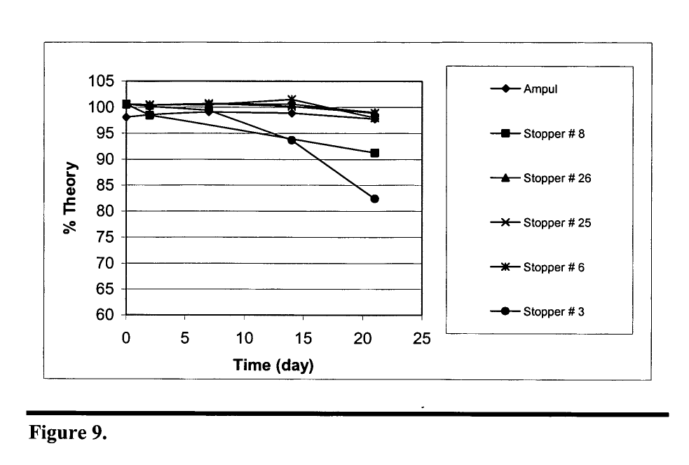

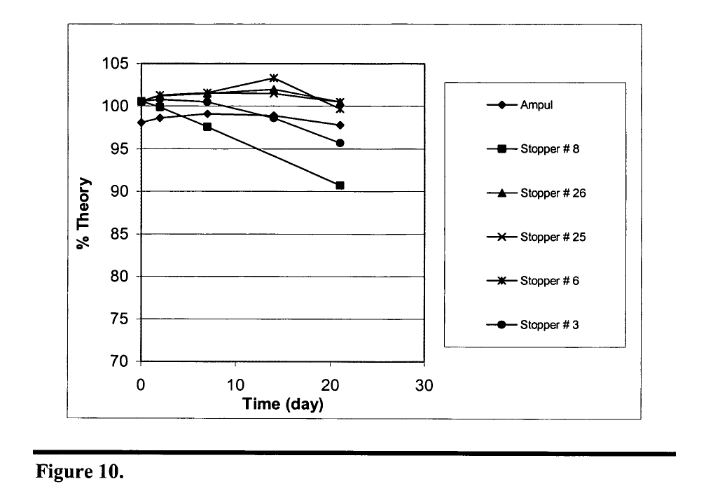

Studies 1-4 were conducted at lab scale. To further test the 4 leading stoppers, Study 5 was conducted wherein the samples were prepared in the pilot plant which most mimic the standard manufacturing methods. Within Study 5, the stoppers were washed and treated before use according to the manufacturing instructions of marketed product. Ampule and vial samples with D777-1/FT/B2-40 stoppers were prepared simultaneously to serve as the controls. The results of study 5 show that the concentration profiles for the West 4432/50 and Daikyo D-21-7 stoppers were similar to the ampule samples (FIGS. 9 and 10). Chlorobutyl and chlorinated butyl stoppers still performed better than D777-1/FT/B2-40 stoppers for paricalcitol solution without headspace argon gassing. The results matched the observations in the lab scale studies and confirmed that chlorobutyl and chlorinated butyl stoppers were compatible with paricalcitol solution.

The results of Example I, wherein an 80° C. stability model compares various stoppers for Zemplar® Injection to predict the long-term stability of a paricalcitol solution show that the polymer type of the stoppers is considered crucial to the stability of paricalcitol solution. The vials sealed with stoppers composed of chlorobutyl or chlorinated butyl provided the slowest rate of decomposition over the 21 days.

### EXAMPLE II

Evaluation of Stopper Extractables in Paricalcitol Solution

In order to study the concentration loss mechanism of the paricalcitol, a similar 80° C. stability study was conducted wherein the samples were analyzed by HPLC to look for extractables which had dissolved into the paricalcitol solution from the stoppers during the storage. The samples were analyzed by a gradient HPLC method with a UV detector set at 210 nm to evaluate potential extractables.

The stoppers tested in this study were washed and treated in the pilot plant prior to preparing the test samples. Following the 21 day 80° C. storage the samples were analyzed by HPLC at a wavelength of 210 nm The chromatogram region between 20-60 minutes was similar for the paricalcitol solutions with selected compatible stoppers. Two major peaks with a retention time around 51 minutes were noted which had identical retention times as the antioxidants, BHT and 2,2′-methylenebis(6-tert-butyl-4-methylphenol), respectively. The HPLC chromatograms indicated that BHT was extracted from West 4432/50 and Daikyo D-21-7 stoppers, and that 2,2′-methylenebis(6-tert-butyl-4-methylphenol) was extracted from Ashland 5212 stoppers regardless of the stopper barriers, such as Teflon, Flurotec or Tefzel. These two peaks of BHT and 2,2′-methylenebis(6-tert-butyl-4-methylphenol) could not be seen in the chromatogram of D777-1/FT/B2-40 stopper samples.

BHT is an antioxidant and is often used to protect chemicals and materials from oxidative degradation and is present in several of the stoppers. Levels of BHT were identified in the test samples during the 21 day, 80° C. storage and during a separate 25, 30, and 40° C. stability studies conducted over a 9-month interval. The average amount of BHT found in the 25, 30, and 40° C. stability studies was found to be about 0.4 mcg/mL. To determine, whether or not BHT would enhance the stability or cause degradation of the paricalcitol solution, a formulation study was conducted to evaluate the effect of BHT on the stability of paricalcitol in the Zemplar® formulation with the current stopper using a 35 day 80° C. degradation model. In this study, different amounts of BHT were added to the Zemplar® formulation with concentrations of 0.05, 0.1, 0.5, and 1.0 mcg/mL. The controls consisted of the Zemplar formulation without BHT contained in ampules and vials sealed with either D777-1/FT/B2-40 or the 4432/50/Flu/B2-40 stoppers. Over the course of the study, the paricalcitol concentration of samples within the ampule and the vial containing the 4432/50/Flu/B2-40 stoppers remained constant throughout the 35 days. Even though all Zemplar formulations with BHT exhibited lower degradation rates than the one without BHT for the current stopper samples, a consistent loss of paricalcitol was still evident. These results show that loss of paricalcitol was not directly related to the presence of BHT. Therefore, causes not fully understood led to the enhanced stabilization of the paricalcitol solution contained in samples with 4432/50/Flu/B2-40 stoppers.

The results of Example II were inconclusive in determining a source of degradation by measuring potential extractables found in the paricalcitol solution over the course of the 35 day, 80° C. stability study. Although, antioxidants were found in certain test samples, it did not appear that the samples containing BHT contributed to the degradation or stabilization of the paricalcitol solution.

What is claimed is:

1. A method of preventing the decomposition of a pharmaceutical comprising the step of storing the pharmaceutical in a glass vial sealed with a stopper comprising a halogenated butyl polymer selected from the group consisting of chlorobutyl, chlorinated butyl, fluorobutyl and fluorinated butyl for a time and under conditions sufficient to prevent said decomposition.

2. The method according to claim 1, wherein the stopper is comprised of chlorobutyl or chlorinated butyl polymer.

3. The method according to claim 2, wherein the pharmaceutical is in solution.

4. The method according to claim 3, wherein the pharmaceutical is a vitamin D receptor activator.

5. The method according to claim 4, wherein the vitamin D receptor activator is Paricalcitol.

6. The method according to claim 5, wherein the shelf-life of paricalcitol in solution is increased, compared to a solution of paricalcitol stored in a glass vial sealed with a polymer stopper comprising a polymer selected from the group consisting of butyl, bromobutyl, ethylene-propylenediene monomer or polyisoprene.

7. The method according to claim 5, wherein the paricalcitol solution is administered intravenously.

8. A method of preventing decomposition of a solution of paricalcitol in a preloaded syringe comprising adding paricalcitol to a syringe, wherein the syringe stopper is comprised of chlorobutyl or chlorinated butyl polymer, and maintaining said resulting syringe for a time and under conditions sufficient to prevent decomposition of said solution.
